(19) United States
(12) Patent Application Publication
(10) Pub. No.: US 2026/0257958 A1
(43) Pub. Date: Sep. 3, 2026

(54) Method and device for machining workpieces

(71) Applicant: SCHOTT AG, Mainz (DE)

(72) Inventors: Jens Ulrich THOMAS, Mainz (DE); David SOHR, Mainz (DE); Andreas KOGLBAUER, Mainz (DE); Andreas ORTNER, Mainz (DE)

(21) Appl. No.: 18/873,401

(22) PCT Filed: Jun. 6, 2023
(86) PCT No.: PCT/EP2023/065076

§ 371 Date: Dec. 10, 2024

(30) Foreign Application Priority Data
Jun. 23, 2022 (DE) 10 2022 115 711.3

(51) Int. Cl. C03B 33/02; B23K 26/02; B23K 26/352

(52) U.S. Cl. CPC C03B 33/0222; B23K 26/02; B23K 26/352

(57) ABSTRACT

A method for machining a workpiece irradiated with laser light. of the workpiece is at least partially transparent to the laser light such that the laser light penetrates into the workpiece. The laser light is concentrated by a beam-shaping optical unit in a focusing zone having, in cross section perpendicular to the beam axis, a flattened shape with a length situated in the beam direction and a width and thickness which are each perpendicular to the length, wherein the thickness of the focusing zone, at least at one position along the beam axis, is smaller by at least a factor of 5 than the width and the length of the focusing zone, and wherein within the focusing zone, on account of the intensity of the laser light in the material of the workpiece, there is inserted a modification zone which, corresponding to the focusing zone, has a flattened shape.

The invention generally relates to material processing. In particular, the invention relates to the use of laser radiation to process materials transparent to light in at least one wavelength range.

### BACKGROUND

Contactless methods for the separation of materials are known from the prior art. Some of these separation methods make use of laser radiation. Laser ablation, in particular, should be mentioned in this context. One advantage here is that the method is applicable to virtually any desired materials. However, it is disadvantageous that ablation is generally very slow-especially in comparison with mechanical abrasive methods. A further separation method is based on the action of highly intensive laser radiation in the interior of transparent materials. In this case, nonlinear optical processes lead to material modifications or even the formation of plasma, which damages the material locally. In this case, an at least partially open channel in the material can be formed along the laser beam. Should such local, typically filament-shaped areas of damage or channels be introduced repeatedly along a path with the laser, the workpiece processed thus can easily be separated along the path. A method for separating glasses by stringing together areas of damage in the form of filaments by means of a laser is known, inter alia, from WO 2017/009379 A1 and the further prior art cited therein.

### SUMMARY OF THE INVENTION

This technique of introducing filament-shaped areas of damage along a path and subsequently separating the processed workpiece along the path is soon stretched to its limits should the separation line be curved or even contain corners. In the aforementioned WO 2017/009379 A1, the separation along a curved separation line is rendered possible by virtue of the filaments being introduced at an angle to the surface. However, this is undesirable in many cases. Then again, separation along a separation line with any desired course is possible by way of subsequent etching. Etching leads to the filaments widening until the channels formed thus are connected to one another, and a separation at the separation line is brought about. However, etching is complicated and slow. Therefore, there is a need for further improvement in the processing of workpieces, for instance in the separation of transparent materials by means of a laser by way of creating modifications in the interior of the workpiece.

The method and the device according to this disclosure are based in particular on shaping a laser beam such that a two-dimensionally extended focus is obtained in the material of the workpiece to be separated. Thus, as considered in the direction of propagation of the laser beam, it is not a more or less linear damage or a thin channel that is created in the workpiece but rather a two-dimensional, extended and contiguous modification zone, in particular in the form of a damage zone, which ideally already contains a separation of the material as well. Specifically, provision is made for a method for processing a workpiece, in which the workpiece is irradiated by the laser light of a pulsed laser, the material of the workpiece being at least partially transparent to the laser light such that the laser light penetrates into the workpiece. The modification of the workpiece material is brought about by nonlinear interaction with the laser light on account of the high light intensity, in particular by nonlinear absorption of the laser light. In order to obtain a high light intensity, a beam shaping optical unit is used to focus the laser light in a focusing zone within the workpiece, with the focusing zone having a flattened shape with a length in the beam direction of the laser light and a width and a thickness in the cross section perpendicular to the beam axis or beam direction, or in the transverse profile, with the thickness of the focusing zone in a cross section at at least one position along the beam axis being smaller than the width and the length of the focusing zone by at least a factor of 5. In other words, the focusing zone extends along the beam axis of the laser light and in two directions perpendicular thereto, with the focusing zone in the direction of the one direction perpendicular to the beam axis being narrower than along the beam axis and in the other direction perpendicular to the beam axis by at least a factor of 5. The shape of the focusing zone can thus also be referred to as sheet- or blade-shaped. The thickness and the width in the cross section perpendicular to the beam direction represent a local thickness and width, respectively, of the focusing zone. Thus, the two quantities can vary along the beam direction and generally do vary as well. It is also possible to place a box around the focusing zone. The dimensions of this box can then be referred to as global thickness, width and length.

Within the focusing zone, a modification zone is introduced into the material of the workpiece on account of the intensity of the laser light, the said modification zone having a flattened shape corresponding to the focusing zone, thus having a greater extent in the direction of the beam axis and in one direction perpendicular thereto than in a second direction perpendicular to the beam axis, in particular corresponding to the shape of the focusing zone. The beam axis and the aforementioned first and second direction form an orthogonal coordinate system in particular. Accordingly, these three directions are pairwise perpendicular to one another. According to a preferred embodiment, the workpiece can then be separated into two parts at the modification zone. According to a development, this separation is spontaneous if the modification zone already brings about a separation of the material. In general, a modification zone is understood to mean a region in the material of the workpiece where the material of the workpiece is modified vis-à-vis the surrounding material. In this context, the modification zone can be a damage zone in particular, i.e. a region in which the material has been damaged. In particular, such damage can also comprise a separation of the material.

Optionally, according to another embodiment, a separation can also be brought about by an additional step, for instance by exerting stress in the material in the region of the modification zone.

Stress can be exerted both mechanically, for instance by way of a compressive, tensile or flexural stress, and thermally, or by heating the surface using a radiation source, for instance a CO₂ laser, or by cooling by way of a nozzle. Spontaneous self-separation is also possible if the glass workpiece is chemically or thermally prestressed.

Pulsed lasers in particular are suitable for the provision of the radiation intensity required to create the modification, in particular material damage. Thus, for glasses and other inorganic materials, for example, so-called ultrashort pulse lasers, the pulses of which have a length in the order of a few 10 ps or less, are particularly suitable for causing corresponding damage zones.

In addition to the separation of workpieces, other types of processing by way of material modification are also possible. According to another alternative or additional embodiment, a refractive index change is caused locally in the material of the workpiece, i.e. in the damage zone, by way of the laser light. Especially in comparison with processing for separating the workpiece, such a change in the material properties can be implemented at lower luminous intensities or power densities.

The method is particularly suitable for processing inorganic materials that are transparent to the utilized laser light. Glass in particular is considered here, but also glass ceramic, silicon and also further crystalline materials, for instance crystalline aluminum oxide.

In accordance with the above-described method, a device for carrying out the method is also provided. The device for processing a workpiece comprises, in particular, a laser for emitting laser light, the laser being configured to emit laser light at a wavelength at which the workpiece is at least partially transparent such that the laser light can penetrate into the workpiece. Furthermore, the device comprises, in particular, a beam shaping optical unit for focusing the laser light in a focusing zone within the workpiece, with the beam shaping optical unit being designed such that the focusing zone of the laser light created therewith has a flattened shape with a length in the beam direction and a width and a thickness, with the width and thickness being perpendicular to the length direction, with the directions of width, thickness and length thus being pairwise perpendicular to one another and with the thickness of the focusing zone being smaller than the width and the length of the focusing zone by at least a factor of two, preferably by at least a factor of 5. The laser and the beam shaping optical unit are furthermore designed such that there is a sufficient intensity of the laser light within the focusing zone to introduce a damage zone in the material of the workpiece, the said damage zone having a flattened shape, in particular such that the damage zone, in a manner corresponding to the shape of the focusing zone, has a greater extent in the direction of the beam axis and in one direction perpendicular thereto than in a second direction perpendicular to the beam axis. The workpiece to be separated can also be a constituent part of the device. Furthermore, the device can comprise an apparatus for separating the workpiece at the modification zone, in particular an apparatus for exerting mechanical stress on the modification zone.

In an alternative or in addition to the ratios of thickness to width and/or length of the focusing zone, the flattened, e.g. blade-like shape of this zone can also be described by the ratios of the corresponding areas. Thus, in an alternative to that or in addition, provision is made in one embodiment for the laser light to be focused in a focusing zone such that the projection area of the focusing zone considered in the direction of the beam axis of the laser light is smaller than the projection area of the focusing zone considered in the direction of the thickness of the focusing zone by at least a factor of four.

The extents of the focusing zone in the three mutually perpendicular directions, i.e. the beam axis and the other two directions, are denoted thickness w, width b and height L, as already described above. In this case, the height L is the extent of the focusing zone in the direction of the beam axis or beam direction, or the incoming radiation direction of the laser light. The thickness w denotes the extent of the cross section of the focusing zone in a second direction perpendicular to the beam axis, in which the focusing zone is narrower than along the beam axis and narrower than in a first direction perpendicular to the second direction, at least by a factor of 2, preferably at least by a factor of 5. By preference, the beam shaping optical unit is used to create a focusing zone within the workpiece having at least one, preferably all of the following extents:
a width b, i.e. an extent in a first direction perpendicular to the beam axis, ranging from 1 μm to 10 mm, preferably 10 μm to 50 μm,
a thickness w, i.e. an extent in a second direction perpendicular to the beam axis, ranging from 0.2 μm to 50 μm, preferably 1 μm±0.5 μm,
a height L, i.e. an extent along the beam axis, ranging from 2 μm to 20 mm, preferably at least 30 μm, particularly preferably 1 mm to 5 mm.

The invention is explained in more detail below on the basis of the figures. In the figures, the same reference signs refer to identical or corresponding elements in each case.

### BRIEF DESCRIPTION OF THE DRAWINGS

FIG. 1 shows a device for processing workpieces.

FIG. 2 schematically shows a workpiece with damage zones introduced therein.

FIG. 3 schematically shows a cross section of a focusing zone.

FIG. 4 shows an arrangement with a focusing zone positioned completely within the workpiece.

FIG. 5 shows three possible ways of positioning a focusing zone relative to a workpiece.

FIG. 6 shows an arrangement for creating a focusing zone using a Bessel beam.

FIG. 7 shows the intensity curve in a focusing zone in two mutually perpendicular sectional planes.

FIG. 8 shows a laser beam with astigmatic focusing and

FIG. 9 shows the beam cross section of the laser beam at four different positions.

FIG. 10 shows, in a manner similar to FIG. 8, a laser beam with an astigmatic shape, together with idealized three-dimensional beam profiles.

FIG. 11 shows various possible arrangements of an astigmatic laser beam relative to a workpiece to be processed.

FIG. 12 shows a beam shaping optical unit having a diffractive optical element.

FIG. 13 shows a plan view of a diffractive optical element for creating a Gauss-Bessel beam and the phase profile of beamlets that can be created using this mask.

FIG. 14 shows the phase shift caused by a diffractive optical element for two mutually perpendicular directions, as a function of the distance in the radial direction from the center of the element.

FIG. 15 shows a light-microscopic recording of the surfaces of a workpiece processed by laser light.

FIG. 16 schematically shows the position of the focusing regions relative to the surface of the workpiece.

FIG. 17 shows a light-microscopic recording of the surface of a separated workpiece and

FIG. 18 shows the edge surface of a part of the workpiece obtained by the separation.

FIG. 19 shows an optical arrangement for creating a focusing zone curved about an axis perpendicular to the beam direction.

FIG. 20 shows examples with a curved focusing zone, with partial image (a) showing a workpiece irradiated by the focusing zone and partial image (b) showing a perspective illustration of a focusing zone.

FIG. 21, FIG. 22, FIG. 23. FIG. 24, FIG. 25 and FIG. 26 show further embodiments of beam shaping optical units for creating flattened focusing zones.

### DETAILED DESCRIPTION

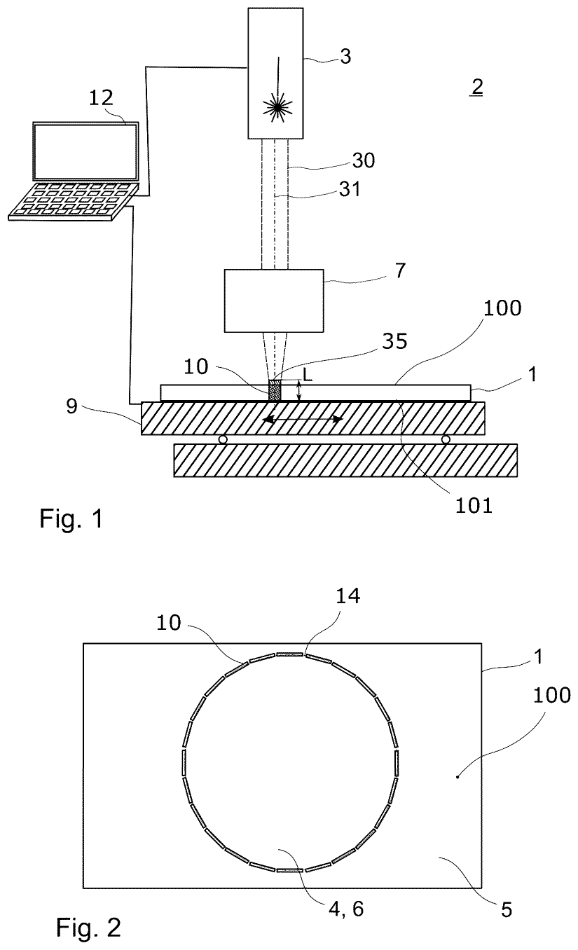

FIG. 1 shows an exemplary embodiment of a device 2 for processing, more particularly separating, a workpiece 1, as is suitable for carrying out the method described herein. In general and without restriction to the example illustrated, the device 2 comprises a laser 3 and a beam shaping optical unit 7 as core constituent parts. A workpiece 1 to be processed is arranged upstream of the beam shaping optical unit 7 in the beam direction of the laser 3 such that the focusing zone 35 created out of the laser light, or the laser beam 30, by the beam shaping optical unit 7 is located at least partially within the workpiece 1.

The laser 3 is sufficiently powerful for the intensity of the laser light 30 to cause material modification in a modification zone, preferably in the form of a damage zone, within the part of the focusing zone 35 located in the workpiece 1, said modification zone facilitating or already bringing about the separation of the element 1 at the damage zone.

An ultrashort pulse laser, preferably with pulse durations in the order of picoseconds, in particular operable with pulse durations below 50 ps, is particularly suitable. Unlike in previously used devices for laser-based separation of workpieces by introducing filament-shaped damage or thin channels, provision is made for the focusing zone 35 and, accordingly, the damage zone 10 to have a flattened shape. Depending on the focusing properties, the focusing zone can have different forms, for example the shape of a flattened ellipsoid or simply of a significantly flattened cuboid or a flat disk.

In general, a flattened focusing zone 35 can be obtained by an astigmatic or caustic beam shaping optical unit 7. In one embodiment, at least one cylindrical lens can be provided as a constituent part of the beam shaping optical unit 7.

In general, a different refractive optical element can also be used in an alternative or in addition to a cylindrical lens. Thus, one embodiment provides for a free-form optical unit. A phase mask as a constituent part of the beam shaping optical unit 7 is particularly preferred. A phase mask makes it easy to create a focusing zone 35 which simultaneously has a great length and a small thickness. A cylindrical lens or, in general, an optical unit with different refractive powers in mutually perpendicular directions, by contrast, tends to see a reduction in the width also be accompanied by a shortening of the focusing zone.

The phase mask is designed as a diffractive optical element according to one embodiment. Any other phase mask, for instance an LCOS spatial light modulator (SLM), can also be a constituent part of the beam shaping optical unit as element for creating the flattened focusing zone as described here. An LCOS-SLM is a reflective spatial light phase modulator which can freely modulate the optical phase. In so doing, the optical phase of the laser is modulated by way of a liquid crystal. Thus, in general, the beam shaping optical unit 7 might also comprise a liquid crystal element for the phase modulation of light. In general, the focusing zone 35 and the modification zone 10 need not coincide. In particular, the focusing zone 35 can thus already start outside of the workpiece 1 and/or end outside of the workpiece 1. In the example illustrated, the length L of the focusing zone 35, i.e. its dimension in the direction along the beam axis 31 of the laser light 30, is greater than the thickness of the workpiece 1. In this case, the focusing zone 35 projects beyond both opposing side surfaces 100, 101 of the workpiece 1, which is flat in this example, while it is self-evident that the greatest extent of the modification zone 10 is between the two side surfaces 100, 101. Without restriction to the illustrated example, the method is particularly preferably applied to flat workpieces 1. Furthermore, as in the case of the illustrated example, too, the modification zone is introduced such that the direction of the width of the damage zone is along the side surfaces 100, 101 or at right angles to the surface normal of a side surface 100, 101. The modification zone 10 is thus embodied as a narrow cut in a side surface 100, 101, which in this way facilitates a separation of the workpiece 1 into parts.

To set the position of the one or more damage zones 10 to be introduced, a positioning apparatus 9 is provided according to a preferred development of the device 2. Both the positioning apparatus 9 and the optical system, especially the laser 3 in this case, can preferably be program-controlled by means of a controller 12. In the illustrated example, the positioning apparatus 9 comprises an xy-table, onto which the flat workpiece 1 is placed. On account of the flattened, blade-shaped focusing zone created using the arrangement described here, the orientation of the said focusing zone relative to the beam axis is also relevant. To set this orientation, one embodiment provides for the optical system, or the beam shaping optical unit 7, to be designed to be rotatable about the beam axis. In an alternative to that or in addition, the workpiece can also be rotated about the beam axis in order to obtain a desired orientation of the focusing zone within the workpiece. Therefore, an alternative or additional embodiment provides for the positioning apparatus to have an axis of rotation in order to rotate the workpiece vis-à-vis the laser beam about a direction parallel to or collinear with the beam direction.

Optionally, especially in the case of small workpieces, a single modification zone 10 is already sufficient to separate the workpiece 1. However, in a preferred configuration, a plurality of modification zones 10, preferably in the form of damage zones, are strung together such that these follow an envisaged separation line 14, with the workpiece 1 being separated at the separation line 14 such that two parts 4, 5 are obtained. To elucidate this, FIG. 2 shows a flat workpiece 1, once again as an example here, having a plurality of such strung-together modification zones 10. The workpiece 1 is depicted in a plan view of a side surface 100. The cross-sectional area of the modification zones 10 from a direction perpendicular to the length L is visible in this illustration. As a result of the flattened geometry of the damage zone 10, the latter is identifiable as an elongated shape from the side surface 100, illustrated here in simplified fashion as an elongated rectangle. In this case, it is advantageous to string together the modification zones 10 such that the longitudinal directions of the elongate cross sections of the modification zones 10 are aligned along the separation line 14. In other words, the modification zones 10 are oriented such that the separation line 14 extends in the direction of the width of the modification zones 10.

The introduction of flattened, cut- or gap-like modification zones 10, as provided for by the invention, moreover also enables a simpler separation of the workpiece 1 along a curved separation line 14, or a separation line at least curved along one section, without a final separation being assisted or caused by an additional etching step. An alternative or additional development therefore provides for the damage zones 10 to be introduced along a separation line 14 that is curved at least sectionally. Moreover, a further difficulty with separation arises when the separation line 14 is closed, as is also the case in the illustrated example. This, too, can be implemented much more easily using the method described here, in comparison with a pre-separation by the introduction of filament-shaped damage. According to another alternative or additional embodiment of the method, modification zones 10 are thus introduced along a separation line 14 that is closed in on itself, and an inner part that is bounded by this separation line is then preferably separated from the workpiece 1. In the example illustrated, the part 4 is an inner part 6. In this case, the separation line 14 is circular, and the inner part 6 accordingly has the shape of a circular disk.

The modification zones 10 are still spatially separated in the illustrated example. In general, however, it is also possible to allow the modification zones 10 to overlap, in order to further facilitate the separation into the parts 4, 5.

However, in addition to stringing together the cuts in the longitudinal direction, it is also possible to introduce the modification zones 10 with their widths pointing at one another. A correspondingly wider region with material modifications is created in this way. This can also facilitate cutting out inner parts. Another option lies in not separating the workpieces but producing a depression that is open on one side by introducing modification zones located next to one another into a workpiece multiple times. For example, this also allows the creation of hinges in brittle materials, for instance by locally reducing the thickness of the workpiece. Furthermore, this can also modify the stress in the material. Thus, a kink or a bend in the workpiece 1 can be created in the case of prestressed glass if the compressive stress is reduced locally there, at least on one side, by means of a material modification. Furthermore, other material modifications which do not require material removal can also be implemented. Refractive index changes, inter alia, are considered here. Thus, extensive refractive index changes can be caused by means of material modification, for example in order to produce dielectric reflectors, for instance in the form of volume Bragg gratings.

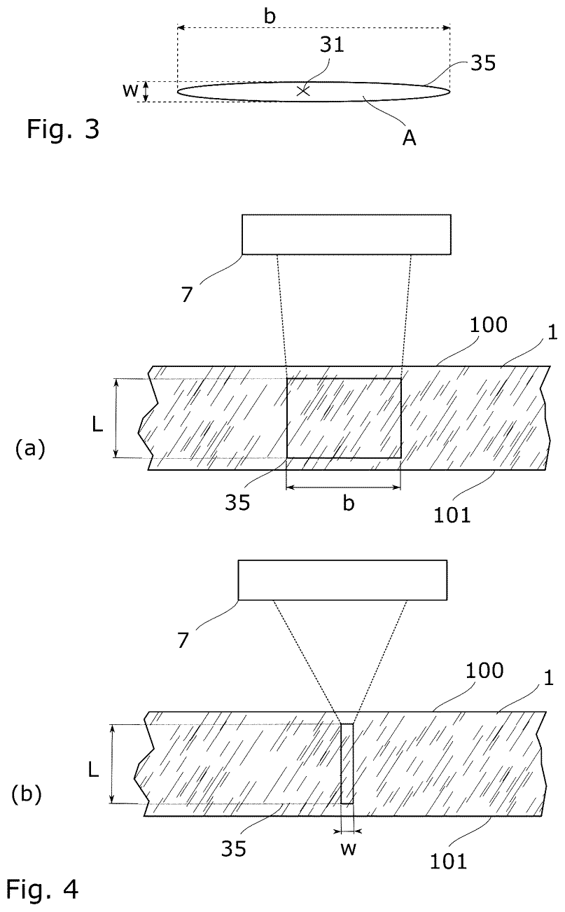

FIG. 3 schematically shows a cross section A of a focusing zone 35, as viewed in a direction along the beam axis 31. In this direction, the dimensions of the width b and thickness w can be read from the cross section at the location of maximal extent of the focusing zone 35. The focusing zone 35 has an elliptical cross section in the example, but it is evident to a person skilled in the art that other cross-sectional shapes are also possible, depending on properties of the beam shaping optical unit 7. The beam shaping optical unit 7 is now designed such that the latter has a sufficiently small cross section in the focusing zone. A preferred embodiment now provides for the use of a pulsed laser 3, the laser light 30 of which is focused in the focusing zone 35 such that the light intensity is sufficiently high for material modification in the workpiece 1. In this context, a preferred embodiment provides for the laser light 30 to be focused in a focusing zone 35 whose cross section A is so small that the light intensity in the focusing zone 35, given by Eₚᵤₗₛₑ/(A·tₚᵤₗₛₑ), exceeds a value of 10¹³ W/cm². In the aforementioned term, Eₚᵤₗₛₑ denotes the energy of a laser pulse and tₚᵤₗₛₑ denotes the pulse duration. In addition to a small cross-sectional area, short pulse durations, in particular, are also advantageous for obtaining high luminous intensities. Thus, a further embodiment provides for the pulse duration to be shorter than 100 ps. Particularly preferably, the pulse duration ranges from 50 fs to 50 ps.

There are numerous options for dimensioning and positioning the focusing zone 35 relative to the substrate. The length L of the focusing zone 35 can be larger or smaller than the thickness of the workpiece 1. Should the focusing zone 35 be longer than the thickness of the workpiece, the focusing zone 35 can project through both opposing surfaces of the workpiece 1. However, the focusing zone 35 can alternatively also be positioned such that only one surface is passed through, and the focusing zone 35 ends in the workpiece 1. Should the focusing zone 35 be shorter than the thickness of the workpiece, there is the further option of the focusing zone 35 being located completely within the workpiece 1. The latter case is illustrated in FIG. 4. Partial images (a) and (b) show the workpiece 1 in cross section, as viewed from different directions. Partial image (a) depicts the focusing zone 35 in the direction perpendicular to the beam axis and perpendicular to the width b. Partial image (b) shows the focusing zone 35 with a view on the narrow side, i.e. the thickness w. Separation of the workpiece 1 is also intended in this direction. As is evident from the partial images, the length L of the focusing zone 35 is shorter than the extent of the workpiece 1 in this direction, and the focusing zone 35 is located completely within the workpiece 1, between the side surfaces 100, 101 thereof.

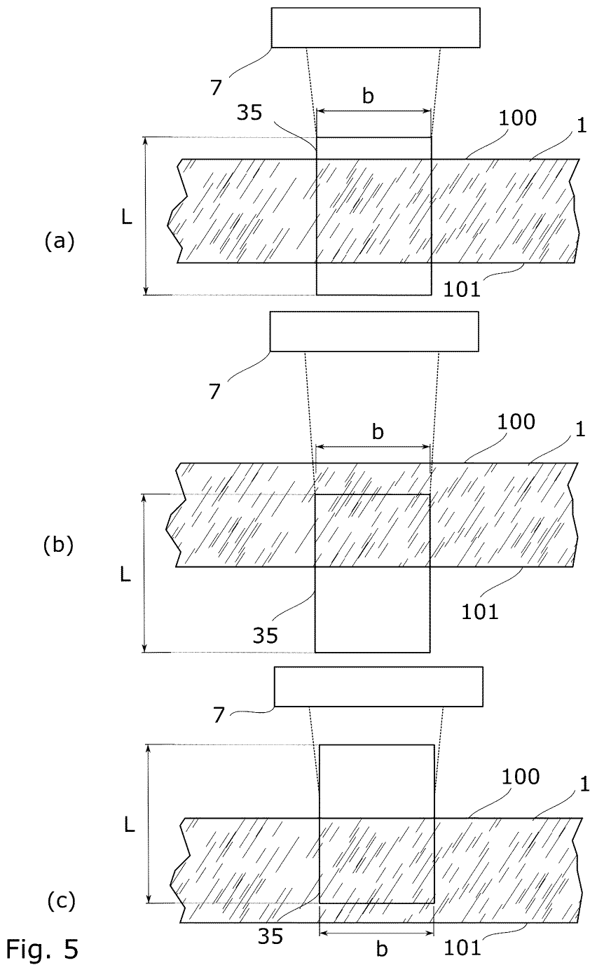

The length L of the focusing zone is greater than the thickness of the workpiece 1 in the examples of FIG. 5. Hence, there is the option of positioning the focusing zone 35 such that these two opposing side surfaces are penetrated, as shown in partial image (a). The focusing zone 35 can likewise be positioned such that, with respect to the beam direction, said focusing zone starts in the workpiece (partial image (b)) or ends in the workpiece (partial image (c)), with one of the side surfaces 100, 101 being penetrated in each case. In summary and without restriction to the specific examples illustrated, the focusing zone can generally be positioned in development of the method such that one of the following features is satisfied:
the focusing zone 35 is located completely within the workpiece 1,
the focusing zone begins or ends within the workpiece 1 and protrudes beyond a tool surface or one of the side surfaces 100, 101 of the workpiece 1,
the focusing zone 35 is longer than the thickness of the workpiece 1 and breaks through two opposing side surfaces, in particular the two opposing side surface 100, 101, of a workpiece 1.

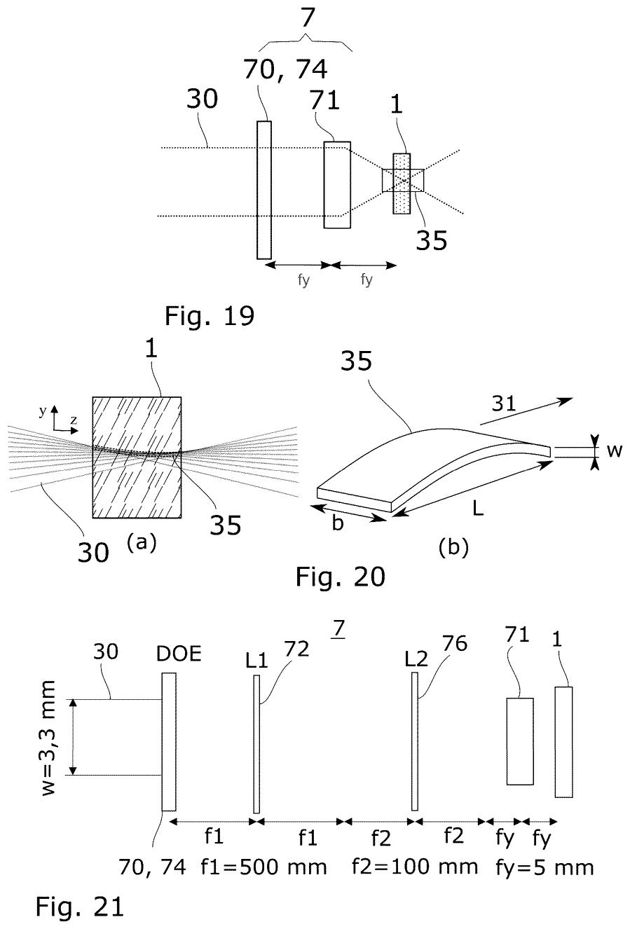

A flattened, blade-like focusing zone 35 can be created in particular by way of astigmatic beam shaping or by way of caustic beam shaping. In particular, a one-dimensional caustic beam shape can also be used to create a corresponding Airy beam, the focusing zone of which is no longer plane but curved around an axis across, preferably perpendicular to, the beam direction. The creation of such beams is also described in Frochly, L.; Courvoisier, F.; Mathis, A.; Jacquot, M.; Furfaro, L.; Giust, R. et al. (2011): “Arbitrary accelerating micron-scale caustic beams in two and three dimensions”, Optics express 19 (17), pp. 16455-16465, DOI: 10.1364/OE.19.016455. The beam profiles and the optical arrangements for the creation thereof are also incorporated in full in the subject matter of the present disclosure. A one-dimensional caustic beam shape is described in more detail below on the basis of FIG. 19 and FIG. 20. In this context, the term “one-dimensional” means that the caustic is formed substantially along a single spatial direction, or that the focusing zone is substantially curved in one spatial direction only.

For the considerations below, the coordinate in the beam direction is defined as z-coordinate. Accordingly, this direction is the direction of the height L of the focusing zone 35. The coordinates x, y perpendicular thereto correspond to the aforementioned first and second directions and span a plane transverse to the beam direction. Without loss of generality, the y-direction is referred to here as the strongly convergent or strongly focusing direction, and the x-direction as the weakly convergent or weakly focusing direction. It is self-evident that it is possible to choose the labels for the directions. Accordingly, the beam can also be strongly convergent in the x-direction.

A convergent beam shape can be achieved by focusing with a refractive surface, in particular a cylindrical lens, for instance like in the example of FIG. 1. In this case f_{y}<<fₓ applies to the focal lengths fₓ and f_{y} in the x- and y-directions. In this case, the focal length is preferably shorter in the y-direction than in the x-direction by at least a factor of 5. With Gaussian optics, L≈2z_{R} applies to the height L of the focusing zone 35, where z_{R} is the Rayleigh length in the xz-plane. Using such an arrangement, it is thus possible to create a focusing zone 35 with a Gaussian profile in the plane spanned by the direction of strong focusing and the beam direction, i.e. the yz-plane.

Other interference patterns which cause a linear focus in a plane spanned by the direction of strong focusing and the beam direction, i.e. in the yz-plane, are also possible. Examples include accelerated beams, such as in particular an Airy beam.

Thus, without a restriction to specific examples, developments of the method and the device 2 provide for a beam shaping optical unit 7 which creates a focusing zone 35 that has the intensity profile of a Gaussian beam, a Bessel beam, or an Airy beam, or at least approximates one of these beams, in a plane.

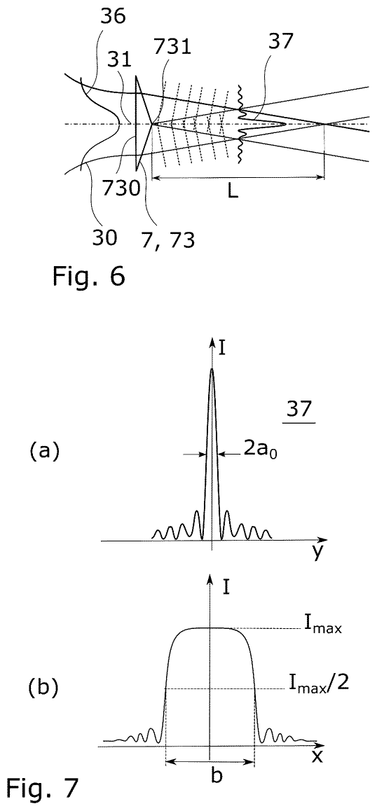

FIG. 6 schematically shows an arrangement for creating a focusing zone 35 using a Bessel beam. In this embodiment, the beam shaping optical unit 7 comprises an axicon 73, the laser beam being directed at the base 730 thereof. A roof prism is not readily suitable as an axicon replacement since a roof prism 73 splits the laser light 30, which originally had an intensity profile preferably in the form of a Gaussian profile 36, into two component beams as a result of refraction at the two mutually inclined refractive surfaces 731, 732, said component beams running toward one another following the exit from the roof prism 73 and crossing one another. However, this does not lead to localization. The Bessel profile 37 is plotted in the region of the crossing beams. As illustrated, the light intensity is greatly intensified in a narrow central region in the case of this profile. This leads to the formation of a flat focusing zone of length L, with this length L substantially corresponding to the length of the region in which the component beams overlap.

FIG. 7 shows the beam profile 37 as it can be created using a phase mask as shown in FIG. 13. In the y-direction, this non-broadened intensity profile approximately corresponds to that of the ideal, rotationally symmetric Bessel beam, as is shown in FIG. 6. Partial image (b) shows the broadened intensity profile in the x-direction perpendicular thereto. The intensity profile is approximately constant in a region in the propagation direction z on account of the non-diffractive character of the Bessel beam. Therefore, references below to the intensity profiles in the xz-plane and yz-plane are equivalent. In the xz-plane, the laser light 30 is weakly focused in part, and so the region of high intensity, which defines the focusing zone 35, is relatively broad in comparison with the region of high intensity in the yz-plane. Without restriction to the examples according to partial image (b) illustrated, the width b of the focusing zone 35 can be defined as the full width at half maximum of the beam profile in this plane. The Bessel profile 37, which forms in the yz-plane, has a width, as defined by its first zeros, of w=a₀λ/(π sin(α)), where λ denotes the wavelength of the laser light 30 and α denotes the half angle of the beam opening or, expressed differently, the effective Bessel cone angle. This value can be defined as the thickness w of the focusing zone 35. The value of a₀ is 2.4044 and is the numerically determined first zero of the Bessel function J₀. Similar values can also be obtained with other prism or lens shapes. Without restriction to the exemplary embodiments or the creation of the focusing zone by means of a roof prism, a development of the method and the device provides in general for the thickness w of the focusing zone 35 to have a value ranging from 1.39 times to 10 times the wavelength of the laser light 30. In general, preference is given to non-diffractive beams, like the aforementioned example of the Bessel beam, for the creation of the focusing zone 35. An Airy beam also represents a non-diffractive beam. Light beams that have a constant intensity profile in the lateral direction along their propagation are referred to as non-diffractive beams. This is in contrast to the usual behavior of light, which spreads out having been focused on a small point.

In practice, the region along the propagation in which the beam has a non-diffractive character is limited on account of the finite lateral aperture dimension of the optical units and the finite energy of the laser beam.

Without restriction to specific exemplary embodiments, provision is therefore made for the beam shaping optical unit 7 to be designed to create a non-diffractive beam that forms the focusing zone 35.

Normally, the optical strength of a focusing element is too weak, and the flattened or blade-like focusing zone 35 would occupy a volume that is too large, to obtain a sufficient intensity for material modification in the workpiece 1. Therefore, one development of the method and the device 2 provides for a minification of the original astigmatic focus. In other words, a magnification factor M<1 is used. According to one embodiment, this minification can be obtained by means of a telescope arrangement, by preference in a 4F-configuration or a 6F-configuration. Without restriction to specific examples, one embodiment therefore provides for the beam shaping optical unit 7 to comprise a 4F- or 6F-arrangement with a magnification M<1. In general, any other reducing optical unit can also be used, i.e. a reducing telescope independently of a 4F- or 6F-configuration, i.e. a telescope with a magnification factor of M<1. In general, the magnification factor is determined by the focal lengths of the optical elements, in particular lenses, contained in the beam shaping optical unit. According to one exemplary embodiment, the beam shaping optical unit comprises a 4F-telescope having a lens with a long focal length f₁=500 mm and a microscope objective with a short effective focal length f_{MO}=10 mm. Hence, this yields a magnification factor of M=f_{MO}/f₁=1/50. Without restriction to this specific example, a development of the device 2 provides for the latter to comprise a beam shaping optical unit 7 having a telescope with a magnification factor M<1/10, preferably M<1/25. In this case, the effect that the minification reduces the area of the focusing zone by a factor of M² transversely and by a factor of M³ longitudinally, i.e. in the beam direction, is also very advantageous with regards to obtaining high beam intensities in the focusing zone. This effect is also elucidated by the following table, in which the reductions in the dimensions of the focusing zone dependent on the magnification factor M are contrasted:

| | Original | Dimension post |
|---|---|---|
| | dimension | minification |
| Thickness | w¢ | w = Mw¢ |
| Width | b¢ | b = Mb¢ |
| Height | L¢ | L = M²L¢ |
| Volume | V¢ = w¢b¢L¢ | V = M⁴V |

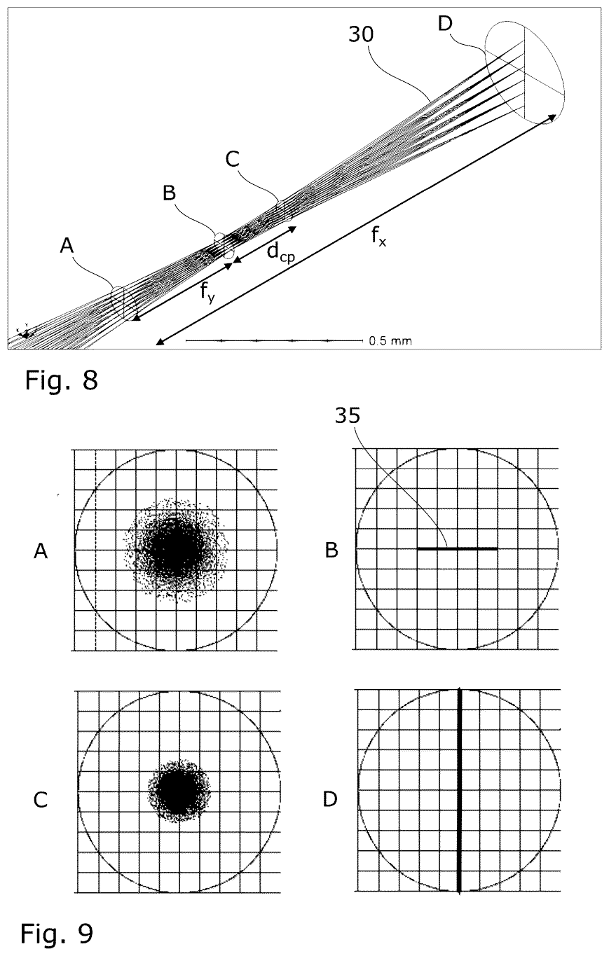

In the sense of this disclosure and in developments, an astigmatic beam shape means in particular that two or more flattened focusing zones oriented at right angles to one another arise in place of a single focal region with a substantially round cross section. This is explained in detail on the basis of FIG. 8 and FIG. 9. In this case, FIG. 8 shows a laser beam focused in astigmatic fashion, and FIG. 9 shows beam cross sections of the laser beam at four different positions. The positions A, B, C, D of the beam cross sections shown in FIG. 9 are plotted in FIG. 8. In FIG. 8, the beam direction of the laser light 30 points from position A in the direction of positions B, C, D. The optical elements for astigmatic beam shaping are not depicted in FIG. 8. The focus of the last lens or last lens system, for instance of a microscope objective, is located at position A. The transverse dimensions of the beam profile at this first transverse conjugate point are substantially the same. The focus of the strongly focusing beam axis in the y-direction is situated at position B. A meridional plane focus line 35, which extends parallel to the x-direction, forms at this position. The second transverse conjugate point is located at position C. Like at position A, the beam profile is substantially circularly symmetric. If the optical system is weakly focusing in the x-direction, then the beam diameter at this second conjugate point is smaller than at the first conjugate point, or at position A. Finally, the focus of the weakly focusing beam axis x, the so-called sagittal focus line which is parallel to the y-direction, is located at position D. If the laser light 30 is additionally shaped by a 4F-arrangement, the respective focal lengths scale by a factor M².

The following relationship applies to the distance d_{cp} between the focus in the strongly focusing direction at position B and the second conjugate point at position C:

$${d}_{cp} = \frac{1 - {f}_{y} / {f}_{x}}{1 / {f}_{x} + 1 / {f}_{y}}$$

Here, f_{y} denotes the focal length in the strongly focusing y-direction, and fₓ denotes the focal length in the weakly focusing x-direction. For the case of a large difference between the two focal lengths fₓ, f_{y}, i.e. if fₓ is substantially longer than f_{y} (fₓ→∞), d_{cp}≈f_{y} follows therefrom.

Moreover, AB=f_{y}, f_{y}≤d_{cp} and AD=fx also applies to the further distances.

Similarly to FIG. 8, FIG. 10 once again shows the laser light formed in astigmatic fashion for the limit case fₓ→∞, but now with idealized three-dimensional beam profiles depicted schematically next to the beam. Secondary focus regions 38, 39 can form in addition to the flattened focusing zone 35 in the case of an astigmatic beam shaping. The focusing zone 35 and the secondary focus regions 38, 39 are depicted in idealized fashion as cuboids in FIG. 10. As shown, the secondary focus regions 38, 39 can also have a flattened shape. These secondary focus regions 38, 39 are typically located in the region of the conjugate points A and C. For a flattened shape, like in the example shown, these secondary focus regions 38, 39 are moreover oriented at right angles to the focusing region 35 with respect to the directions of width b and thickness w. Without restriction to the example shown, one embodiment thus provides for the laser light 30 to be shaped by means of the beam shaping optical unit 7 such that two secondary focus regions 38, 39 with a flattened shape are created in addition to the focusing zone 35, with the focusing zone 35 being arranged between the secondary focus regions 38, 39 in the beam direction. In developments in this context, the secondary focus regions 38, 39 considered with respect to the directions of their width and thickness are oriented at right angles to the directions of width and thickness of the focusing zone 35 as considered in the beam direction. Depending on the manner of beam shaping, these secondary focus regions 38, 39 typically have a lower light intensity than the focusing zone 35 situated therebetween; however, the said lower light intensity nevertheless might reach the same order of magnitude as in the focusing zone 35. These secondary focus regions 38, 39 can also be referred to as parasitic foci since they are pronounced in their transverse alignment conjugate to the focusing zone and their respective damage zones are therefore located at right angles to the desired alignment of the material modification. Thus, a preferred embodiment provides for the material processing, or the separation of the workpiece 1, to be performed by means of the focusing zone 35 only. This focusing zone 35 typically extends around position B, i.e. around the position of the focus of the strongly focusing direction. Accordingly, a preferred embodiment provides for the beam shaping optical unit 7 and the workpiece 1 to be positioned relative to one another such that the focus of the strongly focusing direction of the astigmatic beam shaping optical unit 7 is located on, or particularly preferably in, the material of the workpiece 1. However, this point might also be located outside of the workpiece 1 in embodiments in which the focusing zone 35 ends or starts in the workpiece 1. For example, such a configuration might be present in examples (b) and (c) of FIG. 5.

A disadvantageous effect of parasitic foci, or the secondary focus regions 38, 39, can be minimized surprisingly well and easily for the processing of transparent workpieces 1, for example made of glass, glass ceramic or crystalline materials. To this end, a first embodiment provides for the beam shaping optical unit 7 and the workpiece 1 to be arranged and/or set relative to one another such that, adjacent to the focusing zone, at least one of the secondary focus regions 38, 39 is located at least partially within the workpiece 1. In that case, the intensity of the laser light 30 can be set such that the light intensity of the secondary focus region 38, 39 is below the threshold for a permanent material modification of the workpiece 1. However, in doing so, the intensity is preferably set in such a way that the light intensity is above this threshold in the focusing zone 35.

According to a further embodiment, the focusing zone 35 is arranged vis-à-vis the workpiece 1 such that the focusing zone 35 is located at least partially within the workpiece 1 and the secondary focus regions 38, 39 are located outside of the workpiece 1. In particular, this can be carried out should the height L of the focusing zone 35 be greater than or equal to the thickness of the workpiece 1 and/or should the distance between the focusing zone 35 and the secondary focus regions 38, 39 be sufficiently large.

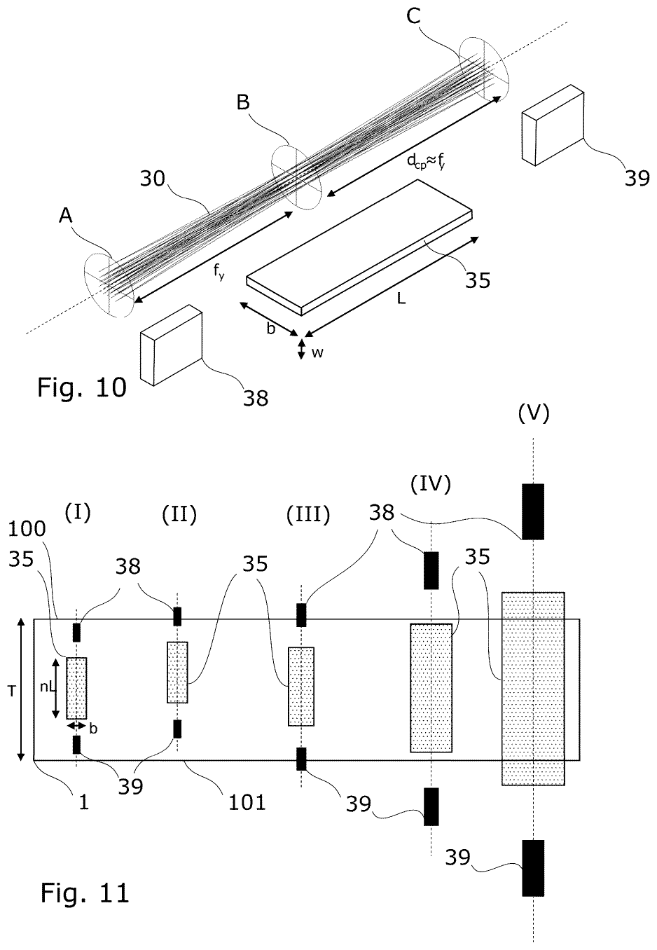

FIG. 11 shows various possible arrangements (I), (II), (III), (IV) and (V) when processing a workpiece 1 using an astigmatic laser beam. Both the focusing zone 35 and the two secondary focus regions 38, 39 are situated within the workpiece 1 in case (I). In this case, it is advantageous if, as described above, the laser power is adapted such that the light intensity of the secondary focus regions 38, 39 is below the threshold for a permanent material modification of the workpiece 1, and the light intensity in the focusing zone 35 is above this threshold. In cases (IV) and (V), the two secondary focus regions 38, 39 are situated so far apart from one another that the position of the laser beam can be positioned such that the secondary focus regions 38, 39 are located outside of the workpiece 1.

In cases (II) and (III), at least one of the side surfaces 100, 101 or at least one surface of the workpiece 1 in each case is situated within one of the secondary focus regions 38, 39. These cases are rather disadvantageous and not preferred. This is due to the fact that the damage threshold for the action of ultrashort pulse laser radiation is typically one order of magnitude smaller at the surface in comparison with within the volume. The processes that lead to the material modification in the workpiece 1 are typically based on multi-photon absorption or avalanche ionization in this case.

What holds true in general is that the length of the focusing zone 35 is longer within the workpiece 1 than outside. Specifically, parts of the focusing zone 35 located within the workpiece lengthen by a factor corresponding to the refractive index of the material of the workpiece 1.

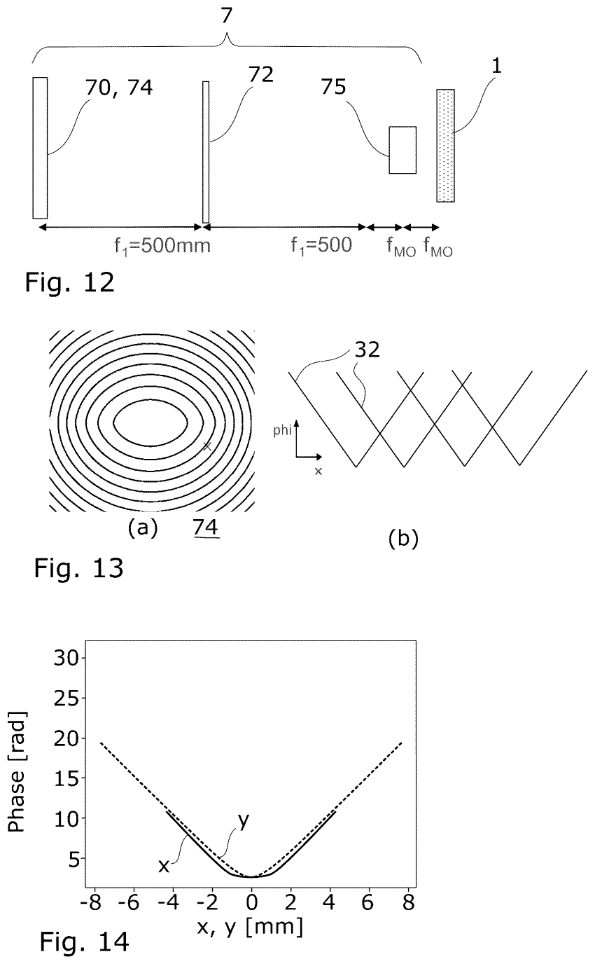

As described above, the beam shaping optical unit 7 for creating an astigmatic laser beam can comprise a roof prism 73 and/or a cylindrical lens 71. A further option lies in the use of a diffractive optical element. Such an element can be designed as a phase mask in particular. For instance, a Bessel-Gauss beam can be shaped from the laser light using such a mask. A further advantage arising from a phase mask is that the focusing zone of the Bessel-Gauss beam can be formed at a certain distance from the beam shaping optical unit 7. This simplifies handling and positioning of the workpiece in the device 2. FIG. 12 shows an exemplary embodiment of such a beam shaping optical unit 7. In general, and without restriction to the example illustrated, a development of the device and method in this case provides for an astigmatic laser beam to be shaped from the laser light using a beam shaping optical unit 7 in which a phase mask 70 forming a diffractive optical element 74 in particular is provided, the latter being arranged upstream of a telescope optical unit or, alternatively, upstream of a reducing arrangement of optical elements or a combination thereof. In the beam direction, the diffractive optical element in the illustrated example is arranged upstream of a combination of a lens 72 and an objective 75 positioned to follow said lens in the beam path. In this case, the objective 75 has a shorter focal length than the lens 72, and so a minification is created in correspondence with the ratio of the focal lengths of objective 75 to lens 72. In the illustrated example, the lens 72 has a focal length of 500 mm and the objective has a focal length of 10 mm, leading to a minification with a magnification factor of M=0.02. In particular, the lens 72 can be shaped spherically or aspherically. Furthermore, a laser beam with a diameter of 6.6 mm, which was radiated onto the phase mask 70, was used in the exemplary embodiment.

An embodiment of a phase mask 70 in the form of a diffractive optical element 74 is shown in plan view in FIG. 13, partial image (a). The lines in each case label positions at which the phase has in each case been shifted onward by 2x in the radial direction-starting from the center labeled by a cross. Thus, for example, the phase shift at the second innermost concentric line vis-à-vis the center is 4π. According to one development, which is also realized in the depicted example, the phase mask 70 is generally shaped such that the latter causes the phase of the laser light to be shifted by a growing factor in the radial direction starting from the phase mask center, wherein the period of the phase shifts differs by a factor of 2nπ in two mutually perpendicular directions or wherein the phase shift as a function of the distance from the center is a greater in a first radial direction than in a second radial direction perpendicular thereto. According to this definition, the first direction is vertical starting from the center in the example illustrated, and the second direction is horizontal. In this respect, FIG. 14 additionally shows the phase shift for the directions of x (horizontal direction in FIG. 13) and y (vertical direction in FIG. 13), specified in radians. According to one exemplary embodiment, the diffractive optical element 74 can be used to create a phase distribution of Bessel beamlets with an angle to the beam axis of 7.5°, or an overall angle of 14.8°. Focal lengths can be assigned to the two directions, the said focal lengths being able to be calculated from quadratic fits to the phase distributions, or to the curves shown in FIG. 14. These then correspond to the quadratic phase terms k₀·ρ²/(2f) of a thin lens.

The method of shaping a light area with Bessel beamlets is described below. In this context, a Bessel beamlet denotes an individual conical phase contribution to the beam shape. In this respect, for the x-direction, partial image (b) in FIG. 13 schematically shows the phase profile of Bessel beamlets 32 as may be created using a phase mask 74 according to FIG. 13, partial image (a). The overall phase Øtotal of the phase mask 74 is given by

$${ϕ}_{total} ( ρ ) = \frac{1}{s} {\sum }_{i}^{n} {a}_{i} \vert ( ρ - {ρ}_{i} ) \vert$$

The latter is obtained by addition of n conical components, the Bessel beamlets 32, which are each located at the position ρᵢ=(xᵢ, yᵢ). For example, the following then applies to a linear transverse contour:

$${ρ}_{i} = {ρ}_{start} + \frac{i}{n} ( {ρ}_{end} - {ρ}_{start} )$$

Other transverse contours can likewise be chosen in order to create a light area that extends straight along the beam direction but may have e.g. local curvatures around axes parallel to the beam direction. Phrased alternatively, this beam shaping serves to lengthen any desired lateral contour along the beam propagation such that an area arises which has the same contour in transverse sections at different positions along the beam propagation.

Weighting factors can be used to obtain an advantageous intensity distribution along the line, or along the flattened focusing zone 35 in this case. These weighting factors ai can preferably contain a function of position ρᵢ=(xᵢ, yᵢ). For example, the following can apply:

$${a}_{i} ( {ρ}_{i} ) = c \vert {ρ}_{i} \vert ,$$

where c is a constant.

The overall scaling factor s serves to normalize the sum of the Bessel beamlets 32. For example, an effective opening angle α of the Bessel-Gauss beam is obtained by:

$$s = \frac{2 π}{λ} tan ( α ) {\sum }_{i}^{n} {a}_{i} .$$

The thickness w′ of the focusing zone 35 emerges from the first zero of the Bessel function at 2.405:

$${w}^{′} \approx \frac{2.405 λ}{π sin α}$$

An alternative Bessel beam-based method for creating a light area is described in Alessandro Zannotti; Cornelia Denz; Miguel A. Alonso; Mark R. Dennis: Shaping caustics into propagation-invariant light. In: Nat Commun 11 (1), pp. 1-7. DOI: 10.1038/s41467-020-17439-3, hereby incorporated by reference herein. The beam profiles and the optical arrangements for the creation thereof are also incorporated herein in full in the subject matter of the present disclosure.

The length of the focusing zone can be estimated as 1=w0/cos (α) should a Gaussian beam with a full width at half maximum w0 be used as input beam on the phase mask. Other intensity profiles for the input beam are possible, e.g. a top hat distribution which has a uniform intensity over the entire width. In particular, the amplitude and phase distribution can be adapted such that an intensity distribution that is as homogeneous as possible is obtained along the length of the focusing zone.

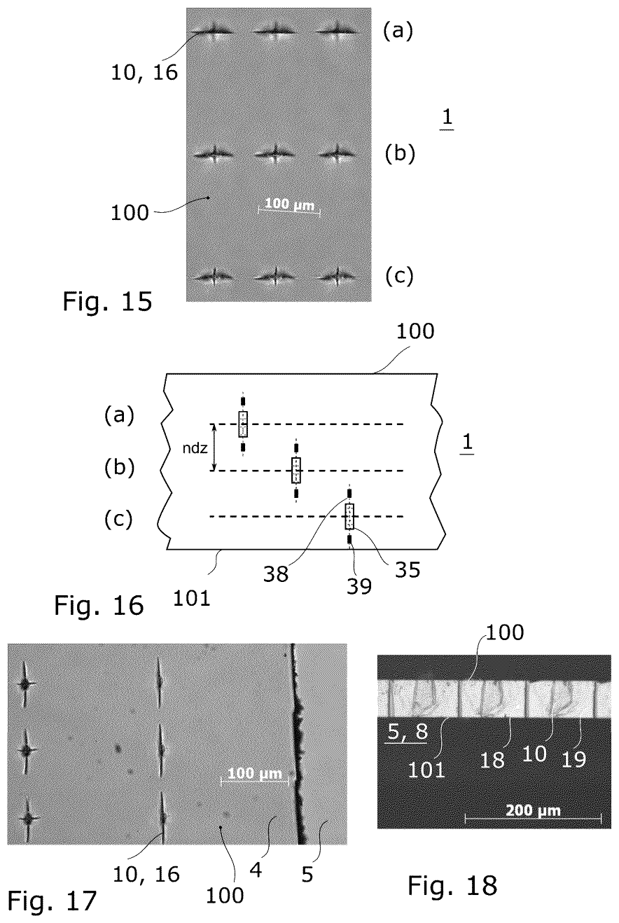

Experimental results of material processing on glass workpieces are shown hereinbelow. In this respect, FIG. 15 shows a light-microscopic recording of the side surface 100 of a workpiece 1 processed by laser light. As evident from the recording, material modifications, or damage zones 10, were introduced into the workpiece 1 made of borosilicate glass in three rows labeled using labels (a), (b), (c). The rows differ in respect of the position of the focusing region relative to the surface. The positions of the focusing zones 35 are illustrated in FIG. 16. What emerges on the basis of FIG. 16 is that the focusing region 35 is closest to the photographed surface in the damage zones of row (a) and furthest down in row (c). However, the focusing zone 35 is positioned completely within the workpiece 1 in all cases. An elongate damage zone 10 in the form of a leaf-shaped gap 16 can be seen in row (a) in particular. Superficial damage by a secondary focus region 38 is also evident in the other damage zones 10, said damage also being leaf-shaped and perpendicular to the main damage, and so overall this gives rise to a damage zone 10 which has the form of a flattened cross with two short and two long arms. For processing purposes, the laser was operated in burst mode with two pulses per burst. In this mode, the laser outputs the laser light in the form of pulse packets, or sequences of pulses emitted quickly in succession. The pulse length of the individual pulses was 1.5 ps, and the overall energy of the burst was 36 μJ. Corresponding to the arrangement of FIG. 12, the focal length was 10 mm. In order to introduce the damage zones 10 at different depths, the distance between workpiece 1 and objective 75 was reduced by dz=20 μm from row to row. The distance in the workpiece was then n·dz, where n is the refractive index of the glass.

The method described herein and the apparatus are particularly preferably used to perform a separation of workpieces 1 into two or more parts, for instance in order to cut out parts with a specific outline from a workpiece in the form of a glass pane. One example in this respect is explained below on the basis of FIG. 17 and FIG. 18. FIG. 17 shows a light-microscopic recording of the surface of a separated workpiece 1, and FIG. 18 shows the edge surface of a part of the workpiece 1 obtained by the separation. To this end, the workpiece from the example of FIG. 15 was ground to a thickness of 40 μm in order to remove the sections of the damage zones 10 caused by the secondary focus regions 38, 39. Subsequently, the workpiece 1 was separated at one of the rows (a), (b), (c) of damage zones 10. The two parts 4, 5 obtained thus are shown placed next to one another in FIG. 17. The special shape and arrangement of the damage zones 10 give rise to a characteristic edge surface of the parts 4, 5, which is depicted in FIG. 18. It is evident that the edge surface 18 of the parts 4, 5 has damage zones 10 which are spaced apart from one another along the edge surface, with fractured surfaces 18 situated between the damage zones 10. Unlike the separation of strung together filament-shaped areas of damage, as known for instance from WO 2017/009379 A1, the damage zones 10 here are substantially flatter in comparison with the extent in the direction along the edge surface 18 or in the circumferential direction. This can be traced back to the flattened, leaf- or blade-shaped form of the focusing zone 35, and hence also to the corresponding extent of the damage zones 10. The damage zones 10 differ from the fractured surfaces 19 in that the damage zones 10 have a material modification, for instance due to a plasma created in the damage zone by the intensive laser light. Accordingly, a part 4, 5 produced thus represents a flat element 8 made of an inorganic material, preferably glass, that is at least partially transparent to laser light, having two opposing side surfaces 100, 101 and a circumferential edge surface 18, the edge surface 18 having fractured surfaces 19 and damage zones 10 in alternation (see, e.g., FIG. 18), with the damage zones 10 comprising a material modification, in particular due to the formation of a plasma within the material of the element, and with the extent of the damage zones 10 in the direction from the edge surface 18 into the element 8 being smaller than in the circumferential direction of the edge surface 18 by at least a factor of 5. In the recording of FIG. 18, the circumferential direction extends from left to right, i.e. it is also parallel to a direction lying on a side surface 100, 101.

A general advantage here is that a separation of a workpiece into parts can be implemented with a comparatively small number of damage zones 10. In the extreme case, separation can already be implemented by a single shot in this case, or by the introduction of a single damage zone 10.

In the previous embodiments, the flattened focusing zone 35 had a flat shape. According to another embodiment, the focusing zone 35 can also have a curved shape. In this embodiment, the focusing zone 35 forms a curved caustic surface. In this case, the flattened, in particular leaf-shaped form of the focusing zone 35 is curved about an axis preferably aligned perpendicular to the beam direction. Such an example is shown in FIG. 20. Partial image (a) shows a side view of a laser beam 30 focused in caustic fashion which passes through a workpiece 1. In general, a beam focused in caustic fashion can be understood to be a beam in which the involved component beams form tangents to an area, or the flattened focusing zone 35. The curved focusing zone 35 arising due to the caustic is labeled by the dashed boundary lines. Caustic focusing is furthermore characterized in that, in idealized fashion, the phase of the laser beam varies in only one direction. For further clarification, partial image (b) shows such a curved focusing zone 35 in a perspective view. For clarification purposes, the width b, height L and thickness w, and the beam axis 31, are plotted. It is evident that the focusing zone 35 has a flattened form despite its curved shape, and a width b and thickness w can be assigned for cross sections perpendicular to the beam axis 31 or beam direction. Unlike the idealized representation, these quantities may vary along the focusing zone 35. Thus, the focusing zone 35 can have a minimal thickness w at least one position along the beam axis 31 in particular. Curved focusing zones 35 are generally particularly advantageous for creating concavely or convexly shaped edge surfaces when separating the workpiece 1.

A possible beam shaping optical unit 7 for creating such a beam with a curved focusing zone 35 is shown in FIG. 19. The beam shaping optical unit 7 comprises a one-dimensional phase mask 70, for example in the form of a diffractive optical element 74. The one-dimensional phase mask 70 is invariant in the x-direction. A cylindrical lens 71 focusing in the y-direction is disposed downstream of the phase mask 70. A one-dimensional phase mask is specifically understood to mean a phase mask having a phase distribution which is constant in one spatial direction, e.g. in the x-direction, and has a non-constant, for example cubic distribution in a direction perpendicular thereto (y-direction). Another component such as e.g. an LCOS-SLM can also serve as a phase mask instead of the diffractive optical element. The boundaries of the focusing zone 35 are represented by dashed lines. It is evident that the focusing zone 35 is curved. Without restriction to specific examples, a focusing zone 35 shaped thus can be obtained using a substantially one-dimensional Airy beam, or an Airy beam compressed in one spatial direction, via beam shaping by means of a suitable phase mask 74. In this case, the complex amplitude of the Airy beam is described by

$${a}_{cub} ( ρ ) = exp [ i \frac{{β}^{3}}{3} {x}^{3} ]$$

with a cubic scaling factor β. This leads to an intensity profile according to the following equation:

$$I ( x , z ) ∝ {Ai}^{2} [ \frac{x}{{x}_{0}} - {( \frac{ξ}{2} )}^{2} + ia ξ ] exp [ 2 a ( \frac{x}{{x}_{0}} - {ξ}^{2} ) ]$$

The following applies to the length L′ of the focusing zone arising therefrom:

$${L}^{′} \approx {z}_{0} = \frac{2 π {x}_{0}^{2}}{λ \sqrt{a}}$$

This length is defined as the length within which the intensity is more than 1/e² of the maximum intensity. The following applies to the full width at half maximum w′ of the focusing zone:

$${w}^{′} \approx 1.6 \cdot {x}_{0}$$

The following applies to the parameters in the equations above:

$${x}_{0} = \frac{β λ f}{2 π} , a = \frac{1}{{w}_{0}^{2} {β}^{2}} , and ξ = \frac{λ}{2 π {x}_{0}^{2}} z .$$

w₀ in this case denotes the full width at half maximum of the Gaussian input beam, onto which the cubic phase is impressed.

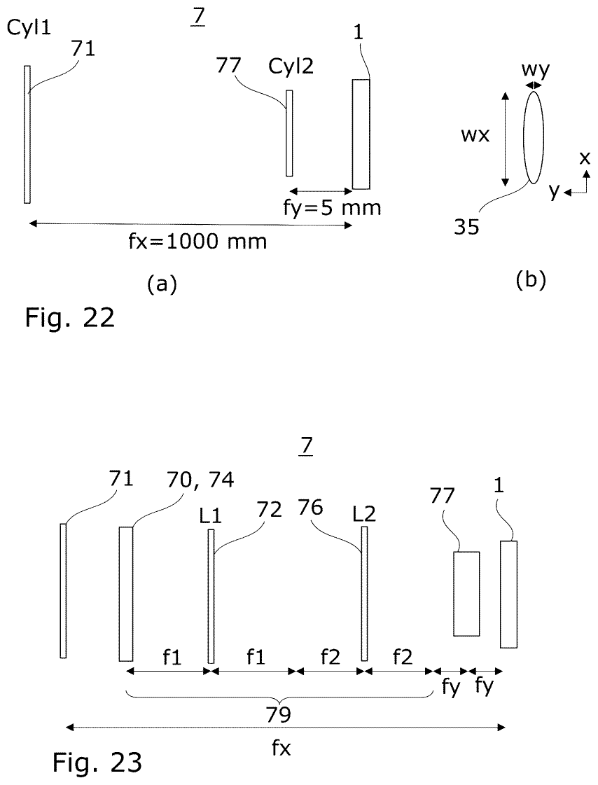

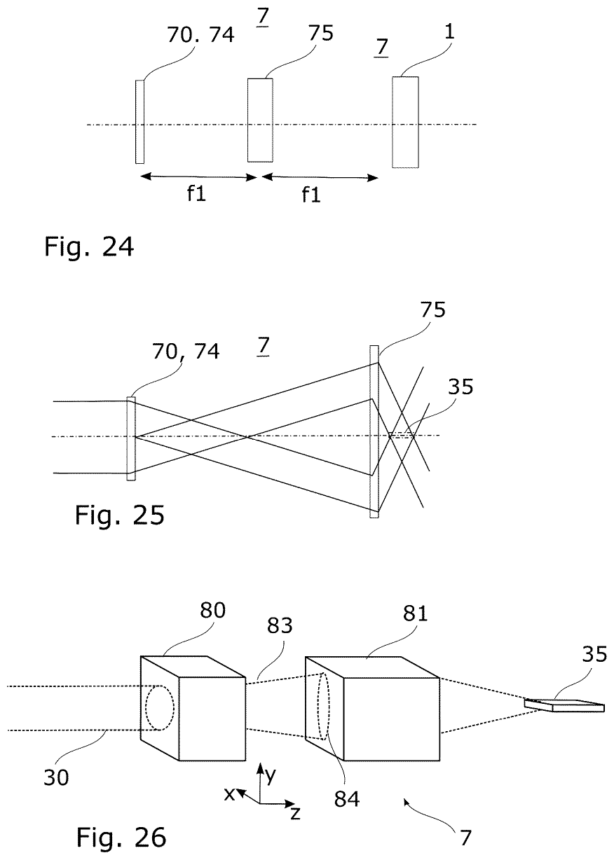

FIG. 21 to FIG. 27 are used to present further embodiments of a device 2 for processing transparent workpieces 1, specifically embodiments of the beam shaping optical unit 7 of such a device 2. The embodiment according to FIG. 21 also provides for a diffractive optical element (DOE) 74 which acts as a phase mask and which is arranged in the beam path of the laser light 30 upstream of a reducing arrangement of optical elements. This arrangement is formed by two lenses 72, 76 and, additionally in the xz-plane, by a cylindrical lens 71. In this case, the workpiece-side lens L2, 76 has a shorter focal length than the lens L1, 72 disposed downstream of the diffractive optical element 74. In the example, the lens L1, 72 has a focal length of 500 mm, the lens L1, 76 has a focal length of 100 mm and the cylindrical lens 71 has a focal length in the y-direction of 5 mm. In order to obtain greater beam focusing in the x-direction, an original beam width of the laser light can also be reduced upstream of the beam-shaping optical unit 7 like in the example. In the example, the beam width is reduced from 6 mm to 3.3 mm.

In general, the embodiment according to FIG. 22 is based on two successively arranged cylindrical lenses 71, 77 with different focal lengths and crossed focusing directions, with the stronger focusing cylindrical lens 77 being arranged on the workpiece side. By preference, the focal lengths of the cylindrical lenses 71, 77 differ by at least a factor of 10. The factor is even 1000 mm/5 mm=200 in the depicted example. Partial image (a) shows the beam shaping optical unit 7 with, arranged in front of it, the workpiece 1 to be processed. Partial image (b) shows the focal region 35 achievable with this arrangement, in cross section in the xy-plane perpendicular to the beam direction. In the simplest case, as illustrated, the focal region 35 has a flat elliptical cross section in the event of an initial beam with a round beam profile. Like in FIG. 22, the foci of the lenses can be located at the same point. This would create a purely elliptical beam without astigmatism. However, this is generally not the case.

The embodiment according to FIG. 23 allows the width of the focusing zone 35 to be set. Moreover, the optical unit can create an Airy beam by means of a suitable phase mask. According to a first aspect, the beam shaping optical unit 7 is characterized in that two nested telescope optical units are provided, independently of whether an Airy beam or a different beam profile, for instance a Gauss-Bessel beam, is created. In this case, a first telescope optical unit comprises two cylindrical lenses 71, 77 and a second telescope optical unit comprises two lenses 72, 76. In particular, the focusing directions of the cylindrical lenses 71, 77 are crossed, like in the embodiment of FIG. 22 as well.

According to a development, which is also realized in the depicted example, the telescope optical unit with the two lenses 72, 76 is arranged between the cylindrical lenses 71, 77. In order to create minification, f2<f1 preferably applies. According to yet another development, provision is made for a phase mask 74, in particular in order to create an Airy beam in one plane in the workpiece 1 such that a flattened focusing zone is obtained. The path between the conjugate points of the inner telescope constructed with the lenses 72, 76 serves as a retardation path 79 for the creation of the Airy beam.

An even simpler configuration is shown in FIG. 24. This embodiment represents a combination of a phase mask 70, which for example forms a diffractive optical element 74, and a 2F-arrangement. As illustrated, the 2F-arrangement can, in the simplest case, be formed by an individual lens, preferably a lens of a microscope objective 75.

FIG. 25 shows a variant of the arrangement of FIG. 24. In the variant according to FIG. 25, a greater distance is chosen between the diffractive optical element 74 and the lens or a microscope objective 75. This arrangement can be referred to as a quasi-4F-configuration. Both arrangements can be characterized to the effect of the beam shaping optical unit comprising a microscope objective 75 and a phase mask, in particular in the form of a diffractive optical element 74, upstream of this microscope objective 75 as the last elements on the light output side. No further beam-shaping elements are provided in the beam shaping optical unit 7 according to one development.

Under certain circumstances, the power of the laser might be insufficient to attain a light intensity sufficient for material modification or, in particular, damage within the focusing zone 35. One option for attaining higher intensities is described below. The beam shaping optical unit including the beam shaping optical unit 7 can be designed such that a stronger minification is obtained, i.e. that the focusing zone 35 is further reduced. This can be achieved by virtue of a beam with an elongate beam profile being created from the laser beam 30 prior to focusing. During focusing, this leads to the extent of the focusing zone being further reduced in the direction in which the beam profile is elongated in the beam shaping optical unit 7 prior to focusing. This effect is explained in more detail on the basis of the schematic example of FIG. 26. According to one embodiment, provision is made here for the beam shaping optical unit 7 to comprises a beam shaping optical unit which reshapes the laser beam 30 in such a way that the latter has an elongate beam profile upon incidence on a focusing optical unit as part of the beam shaping optical unit 7, with the direction of elongation being at an angle, preferably perpendicular, to the direction of the width of the focusing zone 35 and accordingly in the direction of the thickness of the focusing zone 35. In this way, the thickness of the focusing zone 35 is compressed further, and the intensity in the focusing zone 35 is increased. In the illustrated example, an anamorphic optical unit 80 is provided as a beam shaping element, the latter creating an output beam which has a beam profile elongated in the y-direction upon incidence on a focusing optical unit 81. As illustrated, the beam profile can be elliptical, and so the semi-major axis of the profile is in the y-direction in the example. In general, the focusing optical unit 81 is arranged in such a way here that the direction of the width of the focusing zone 35 is perpendicular thereto, i.e. in the x-direction in the example. In particular, use of an elliptical input beam with a sufficiently small semi-minor axis can achieve an increase in the width of the focusing zone even in the event of focusing by a rotationally symmetrically focusing lens, e.g. by a microscope objective.

In general, the use of a high-performance laser with a power of at least 100 W, preferably at least 150 W, is advantageous for material modifications in the focusing zone, up to a separation of the material or the creation of a gap. Hereinbelow, exemplary embodiments of suitable parameters for the laser and the beam shaping optical unit are listed in the tables below. The first table lists suitable laser parameters for an arrangement according to FIG. 22.

### Laser Parameter

| Burst | 300 |
|---|---|
| Pulses per burst | 1 |
| Pulse duration [ps] | 3 |
| Gaussian beam shaping | |
| Beam diameter D [mm] | 6.6 |
| Wavelength 2 [um] | 1.064 |
| fy [mm] | 24.4 |
| fx [mm] | 243.6 |
| NAy | 0.14 |
| Thickness: w = 2 wo [um] | 5.0 |
| Width [um] | 50 |
| Height: L = 2 x Rayleigh length | 148 |
| [μm] | |
| Intensity in the center plane | 4.0E+13 |
| [W/cm²] | |

The parameters of the following table are suitable for an embodiment according to FIG. 12.

| Laser parameter | |
|---|---|
| Burst [μJ] | 250 |
| Pulses per burst | 1 |
| Pulse duration [ps] | 3 |
| Telescope setup | |
| Beam diameter D [mm] | 6.6 |
| f₁ [mm] | 1000 |
| f₂ [mm] | |
| f_{MO} [mm] | 10 |
| M | 0.01 |
| Gaussian beam shaping | |
| Wavelength 2 [μm] | 1.064 |
| Beam diameter downstream of | 0.066 |
| MO-objective [mm] | |
| Effective focal length x of PM | 5,000 |
| [mm] | |
| Effective focal length y of PM | 1,200 |
| [mm] | |
| fx downstream of MO-objective | 500 |
| [um] | |
| fy downstream of MO-objective | 120 |
| [um] | |
| NAy downstream of MO-objective | 0.28 |
| d_{cp} [μm] | 74 |
| Thickness of 35: w=2 wo [μm] | 2.5 |
| Width of 35 [um] | 66 |
| Height: L = 2 x Rayleigh length | 36 |
| [μm] | |
| Intensity in the center plane | 5.1E+13 |
| [W/cm²] | |

The following table specifies laser parameters for Bessel-Gauss beam shaping for three exemplary embodiments:

| | BG- | BG- | BG- |
|---|---|---|---|
| | Beamlet | Beamlet | Beamlet |
| | 1a | 1b | 1c |
| Telescope setup | | | |
| | 30 | | |
| Beam diameter D [mm] | 6.6 | 6.6 | 6.6 |
| f? [mm] | 500 | 500 | 500 |
| f2 [mm] | | | |
| fMo [mm] | 10 | 20 | 20 |
| M | 0.02 | 0.04 | 0.04 |
| Glass refractive index | 1.47 | 1.47 | 1.47 |
| Wavelength A [um] | 1.064 | 1.064 | 1.064 |
| Beam diameter | | | |
| downstream | | | |
| of MO-objective [mm] | 0.132 | 0.264 | 0.264 |
| Width [μm] | 132 | 264 | 264 |
| Bessel-Gauss | | | |
| beam shaping | | | |
| Bessel angle in air [°] | 0.38 | 0.38 | 0.15 |
| Bessel angle downstream | | | |
| of the telescope [°] | 18.4 | 9.4 | 3.8 |
| Bessel angle | 12.4 | 6.4 | 2.6 |
| in the glass [°] | | | |
| Thickness w BG [μm] | 2.6 | 5.0 | 12.3 |
| Width b [μm] | 132 | 264 | 264 |
| Ideal Bessel height: L = | 198 | 794 | 1985 |
| D/2tana [μm] | | | |
| Measured length of | 20 | 100 | 250 |
| the usable | | | |
| focusing zone [μm] | | | |
| (determined | | | |
| from ablation patterns) | | | |

The following table specifies suitable laser parameters for shaping an Airy beam with a curved focusing zone 35. An arrangement according to FIG. 12 is also suitable for these parameters:

Telescope setup

| Beam diameter D [mm] | 6.6 |
|---|---|
| f1 [mm] | 200 |
| f2 [mm] | 300 |
| fMo [mm] | 10 |
| M | 1.50 |
| Glass refractive index | 1.47 |
| Wavelength 2 [μm] | 1.064 |
| Beam diameter downstream of MO- | 0.0135 |
| objective [mm] | |
| Width [μm] | 14 |
| Airy beam shaping: | |
| beta cubic phase [/m] | 1082 |
| Thickness w BG [μm] | |
| (w = 1.6 x0 = 1.6*beta / k) | 29 |
| Width b [μm] | 14 |
| Height: Airy focus length in air [μm] | |
| (l = 2*wo * f ** 2 * beta ** 3 / k) | 1433 |

### LIST OF REFERENCE SIGNS

| | |
|---|---|
| 1 | Workpiece |
| 2 | Device for processing |
| | a workpiece 1 |
| 3 | Laser |
| 4, 5 | Parts of 1 |
| 6 | Inner part |
| 7 | Beam shaping optical unit |
| 8 | Flat element |
| 9 | Positioning apparatus |
| 10 | Damage zone |
| 12 | Controller |
| 14 | Separation line |
| 16 | Gap |
| 18 | Edge surface |
| 19 | Fractured surface |
| 30 | Laser light, laser beam |
| 31 | Beam axis |
| 32 | Beamlet |
| 35 | Focusing zone |
| 36 | Gaussian profile |
| 37 | Bessel profile |
| 38, 39 | Secondary focus region |
| 70 | Phase mask |
| 71, 77 | Cylindrical lens |
| 72, 76 | Lens |
| 73 | Elliptical axicon |
| 74 | Diffractive optical element |
| 75 | Microscope objective |
| 79 | Retardation path |
| 80 | Anamorphic optical unit |
| 81 | Focusing optical unit |
| 83 | Output beam of 80 |
| 84 | Elongate beam profile |
| 100, 101 | Side surfaces of 1 |
| 730 | Base of 73 |
| 731 | Cone tip of 73 |
| 732 | Strongly focusing direction |
| 733 | Weakly focusing direction |

What is claimed is:

1-18. (canceled)

19. A method for processing a workpiece irradiated with laser light of a laser, the method comprising:
penetrating the laser light into the workpiece, a material of the workpiece (1) being at least partially transparent to the laser light;
focusing the laser light in a focusing zone within the workpiece via a beam shaping optical unit, the focusing zone, in cross section perpendicular to the beam axis, having a flattened shape with a length in a beam direction and a width and a thickness in each case perpendicular thereto, with a thickness of the focusing zone at least one position along the beam axis being smaller than the width and the length of the focusing zone by at least a factor of 5; and
introducing a modification zone having a flattened shape corresponding to the focusing zone within the focusing zone on account of an intensity of the laser light in the material of the workpiece.

20. The method as recited in claim 19 further comprising at least one of the following processing steps is performed on the workpiece:
separating the workpiece into two parts at the modification zone; and
as a result of the laser light, causing a refractive index change in the damage zone within the material of the workpiece.

21. The method as recited in claim 20 wherein the focusing zone within the workpiece as at least one of the following dimensions:
the width ranging from 1 μm to 10 mm;
the thickness ranging from 0.2 μm to 50 μm;
the thickness ranging from 1.39 times to 10 times a wavelength of the laser light,
the height ranging from 2 μm to 20 mm; and
a projection area considered in the direction of the beam axis of the laser light smaller than the projection area of the focusing zone considered in the direction of the thickness of the focusing zone by at least a factor of four.

22. The method as recited in claim 19 wherein the workpiece is made of inorganic material.

23. The method as recited in claim 19 wherein the workpiece is made of glass, glass ceramic or a crystalline material.

24. The method as recited in claim 19 wherein the focusing zone is created by astigmatic beam shaping or caustic beam shaping.

25. The method as recited in claim 19 wherein the focusing zone has a curved shape, the focusing zone being curved around an axis perpendicular to the beam direction.

26. The method as recited in claim 25 wherein laser light is shaped by the beam shaping optical unit such that two secondary focus regions with a flattened shape are created in addition to the focusing zone, with the focusing zone being arranged between the secondary focus regions in the beam direction.

27. The method as recited in claim 26 further comprising at least one of the following features:
the beam shaping optical unit and the workpiece are arranged and set such that, adjacent to the focusing zone, at least one of the secondary focus regions is located at least partially within the workpiece, with an intensity of the laser light being set such that a light intensity of the secondary focus region is below the threshold for a permanent material modification of the workpiece and the light intensity is above this threshold in the focusing zone, and
the focusing zone is arranged vis-à-vis the workpiece such that the focusing zone is located at least partially within the workpiece and the secondary focus regions are located outside of the workpiece.

28. The method as recited in claim 19 wherein at least one further modification zone is strung together with the modification zone to define a predetermined separation line, with the workpiece being separated at the separation line such that two parts are obtained.

29. The method as recited in claim 28 further comprising at least one of the following features:
the modification zone and further modification zone are oriented such that the separation line extends in the direction of the width of the modification zone and the further modification zone;
the separation line is curved at least sectionally; and
the separation line is closed in on itself, and an inner part bounded by the separation line is separated from the workpiece.

30. The method as recited in claim 19 wherein the laser light is focused in a focusing zone with cross section A, a light intensity in the focusing zone, given by Eₚᵤₗₛₑ/(A·tₚᵤₗₛₑ), exceeding a value of 10¹³ W/cm², where Eₚᵤₗₛₑ denotes the energy of a laser pulse and t denotes the pulse duration.

31. The method as recited in claim 19 wherein that the focusing zone is positioned such that one of the following features is satisfied:
the focusing zone is located completely within the workpiece;
the focusing zone begins or ends within the workpiece and protrudes beyond one of two opposing side surfaces of the workpiece; and
the focusing zone is longer than a thickness of the workpiece and breaks through both of the opposing side surfaces of the workpiece.

32. A device for processing a workpiece, the device comprising:
a laser for emitting laser light, the laser being configured to emit the laser light at a wavelength, the workpiece being at least partially transparent such that the laser light can penetrate into the workpiece; and
a beam shaping optical unit for focusing the laser light in a focusing zone within the workpiece, the beam shaping optical unit being designed such that the focusing zone created therewith has a flattened shape with a length in the beam direction and a width and a thickness, the thickness of the focusing zone being smaller than the width and the length of the focusing zone by at least a factor of 5,
the laser and the beam shaping optical unit being designed such that there is a sufficient intensity of the laser light within the focusing zone to introduce a modification zone in the material of the workpiece, the modification zone having a flattened shape corresponding to the shape of the focusing zone such that the modification zone has a greater extent in the direction of the beam axis and in one direction perpendicular thereto than in a second direction perpendicular to the beam axis.

33. The device as recited in claim 32 wherein the beam shaping optical unit has at least one of the following features:
the beam shaping optical unit is astigmatic or caustic;
the beam shaping optical unit includes a phase mask;
the beam shaping optical unit includes at least one cylindrical lens; and
the beam shaping optical unit includes a 4F- or 6F-arrangement with a magnification M<1.

34. The device as recited in claim 32 wherein the beam shaping optical unit creates a focusing zone having an intensity profile of a Gaussian beam, a Bessel beam or an Airy beam in a plane.

35. The device as recited in claim 32 wherein the beam shaping optical unit includes at least one of the following optical elements in order to create an astigmatic laser beam:
a refractive optical element;
a cylindrical lens;
a diffractive optical element; and
a phase mask.

36. The device as recited in claim 35 wherein:
the beam shaping optical unit includes a phase mask causing a phase shift of the laser light as a function of a distance from a center of the phase mask to be greater in a first radial direction than in a second radial direction perpendicular thereto,
the beam shaping optical unit includes a phase mask arranged upstream of a reducing arrangement of optical elements; or
the beam shaping optical unit includes a beam shaping optical unit reshaping the laser beam in such a way that the latter has an elongate beam profile upon incidence on a focusing optical unit as part of the beam shaping optical unit (7), with the direction of elongation being at an angle to the direction of the width of the focusing zone.

37. A flat element made of an inorganic material at least partially transparent to the laser light, the flat element comprising:
two opposing side surfaces and a circumferential edge surface, the edge surface having fractured surfaces and damage zones in alternation, with the damage zones including a material modification, and with the extent of the damage zones in a direction from the edge surface into the element being smaller than in the circumferential direction of the edge surface by at least a factor of 5.

38. The flat element as recited in claim 37 wherein the material modification is due to the formation of a plasma within the material of the element.
